(19) United States
(12) Patent Application Publication
(10) Pub. No.: US 2011/0311760 A1
(43) Pub. Date: Dec. 22, 2011

(54) Clicker Keeper

(76) Inventor: Scott Richard Berger, Bishop, CA (US)

(21) Appl. No.: 13/165,772

(22) Filed: Jun. 21, 2011

Related U.S. Application Data
(60) Provisional application No. 61/356,732, filed on Jun. 21, 2010.

(51) Int. Cl. B32B 3/06

(52) U.S. Cl. 428/100; 428/99

(57) ABSTRACT

A remote control locator of the present invention is designed to substantially prevent the loss of remote controls by ensuring that they are visible at all times. This unique device comprises a flag-like accessory such as a ribbon that attaches to the desired remote control, thus making the remote control easy to be spotted when the remote control itself is difficult to find. A wide array of materials, colors, patterns, and sizes can be applied to the invention, making it highly visible for immediate detection of misplaced remote controls.

### REFERENCE TO RELATED APPLICATIONS

This patent application claims the benefit of U.S. Provisional Application No. 61/356,732 filed on Jun. 21, 2010, the disclosure of which is incorporated herein by reference in its entirety.

### BACKGROUND OF THE INVENTION

1. Field of the Invention

The present invention relates to a remote control locator (hereinafter “clicker keeper”) to ensure that remote controls are visible and ready for use, and more particularly to a flag-like accessory such as a ribbon that attaches to the desired remote control, making the remote control easy to be spotted when the remote control itself is difficult to find.

2. Description of Related Art

Many consumers have multiple electronic devices that require remote controls. Keeping track of each remote control can be difficult, especially in households containing multiple individuals. Someone may use a remote control and forget to put it back, or may put it away in a place that is not visible to others. Remote controls can also fall in between couch cushions, under couches and chairs, or become wrapped inside blankets where they may not be found for days or weeks.

U.S. PreGrant Publication No. 20100264176 to Snell discloses a remote control locator kit for users to locate a remote control including the following: an association element physically associate with the remote control; a connection element physically connect to the association element and to physically associate with at least one of the user and a physical object. The association element may be a band or a pouch; the connection element may be a loop. When the connection element is not physically associated with the user or a physical object, they may still be misplaced and may not be visible to be quickly located.

U.S. PreGrant Publication No. 20030217442 to Peterson discloses a remote control locating apparatus including a coupling band for couplingly engaging the remote control; the coupling band is secured to a flexibly extending elongated member at one end thereof; a grasping member for grasping a desired object is coupled to the other end of the flexibly extending elongated member. Although the grasping member is intended to grasp a predetermined object so that the remote control can be secured thereto and readily located, the device too can be easily misplaced, because users may not remember to attach the device to the predetermined object.

U.S. Pat. No. 6,535,125 to Trivett discloses a remote control locator system that can be retro-fitted to any existing remote control device. The remote control locator system comprises a sending unit and a receiving unit. The sending unit sends a locator signal when activated by a user. The receiving unit emits an audible sound when the receiver receives the locator signal. In addition to the invention disclosed in U.S. Pat. No. 6,535,125, there are other remote control locators or finders existing in the marketplace. Because the electronic locator/finders are relatively expensive and complicated to set-ups and use; some consumers may choose not to pay extra money for electronic locators/finders or going through complex set-ups.

Therefore, a simple, cost-effective, and convenient manner is needed to ensure that remote controls are visible and can be quickly located for use.

### SUMMARY OF THE INVENTION

In an exemplary embodiment of the present invention, there is disclosed a clicker keeper designed to substantially prevent the loss of remote controls by ensuring that they are visible at all times.

This unique clicker keeper of the present invention comprises a flag-like accessory that attaches to the desired remote control. Because the flag-like accessory is highly visible, the remote control can be easily spotted and ready for use.

In one embodiment, the unique clicker keeper comprises a ribbon that attaches to the desired remote control, providing a flag-like accessory that can be easily spotted when the remote control itself is difficult to find. A wide array of colors, patterns, and sizes can be applied to the ribbon, making it highly visible for immediate detection of misplaced remote controls. This simple, cost-effective, and convenient method for quickly locating remote controls when they are needed provides effective solution to ensure that remote controls are visible and ready for use.

In one embodiment, the clicker keeper of the present invention comprises a ribbon preferably measuring approximately 1.5 inches in width and 18 inches in length, a first fabric fastening means that is attached to one end of the ribbon, and a second fastening means that matches with the first fastening means to be adhesively affixed to the back of a desired remote control so that the ribbon can be removably applied to the back of a desired remote control via fabric fastening means. In one embodiment, both of the first and the second fastening means may be a strip of sticky-back fabric hook and loop fastener that can be adhesively attached to the ribbon and the back of a remote control, respectively, so that the ribbon can be removably affixed to the remote control via the hook and loop fastener. In one embodiment, the first fabric fastener may also be sewn on the ribbon. Other fastening means known in the art may be used for the intended purpose.

The ribbon can be made of any suitable, durable material, and may be available in a wide variety of colors, patterns, and sizes to make them highly visible. The ribbons can also be interchangeable, allowing consumers to switch the colors and patterns applied to their remote controls as desired. The exact specifications may vary.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is the perspective view of an embodiment of the clicker keeper according to the present invention.

FIG. 2 shows front and back perspective views of an embodiment of the present invention applied to remote controls.

FIG. 3 shows an embodiment of the present invention applied to a remote control, preventing it from becoming lost between the cushions of a chair.

FIG. 4 shows a remote control placed on a window ledge, barely visible.

FIG. 5 shows the aforementioned remote control, now highly-visible due to the application of the invention.

### DESCRIPTION OF THE PREFERRED EMBODIMENT

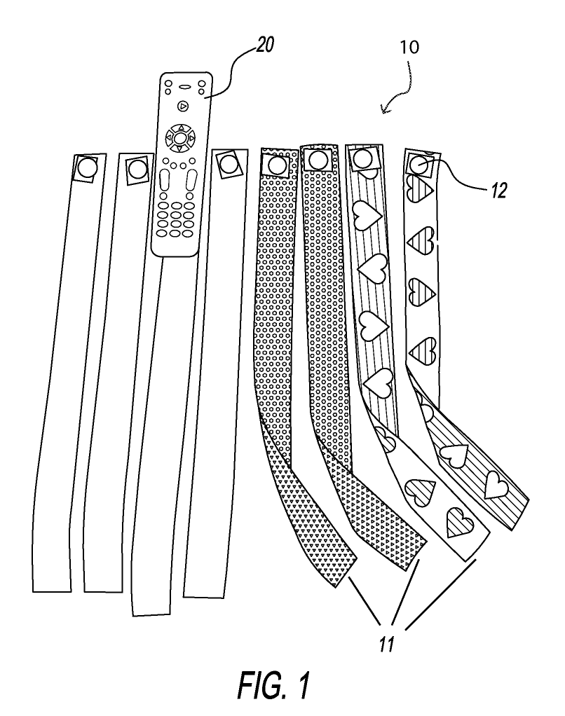

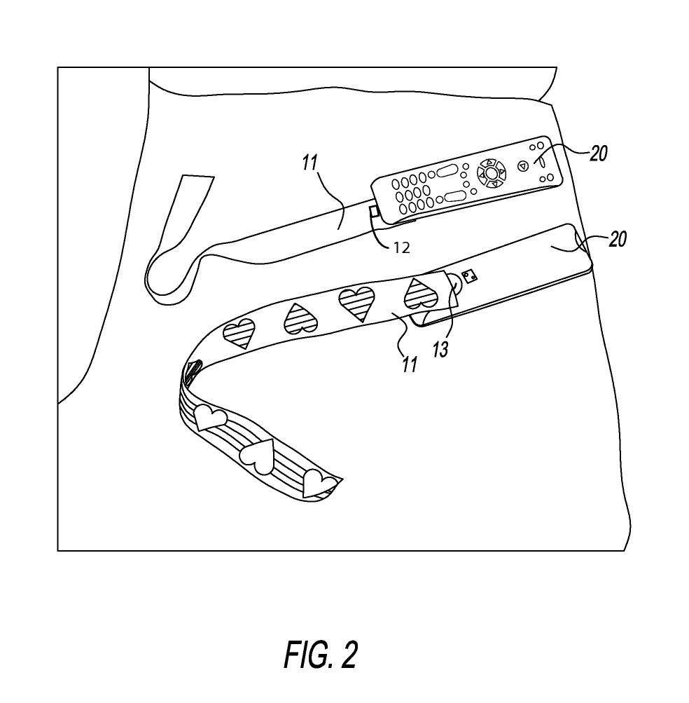

Referring to FIG. 1, there is disclosed an embodiment of a clicker keeper, generally designated by numeral 10, according to the present invention. The clicker keeper 10 comprises a ribbon 11 measuring approximately 1.5 inches in width and 18 inches in length; a strip of adhesive fabric hook and loop 12 that is attached to one end of the ribbon 11; and a strip of corresponding adhesive fabric hook and loop 13 (not shown in FIG. 1), which will be affixed to the back of a desired remote control 20. The ribbon 11 can be made of any suitable, durable material, and may be available in a wide variety of colors and patterns to make them highly visible. The ribbons 11 can also be interchangeable, allowing consumers to switch the colors and patterns applied to their remote controls 20 as desired. The exact specifications for the clicker keeper 10 of the present invention may vary. FIG. 2 shows the front view and the back view of an embodiment of the clicker keeper 10 applied to a remote control 20 via the fabric hook and loop fastener 12 and 13.

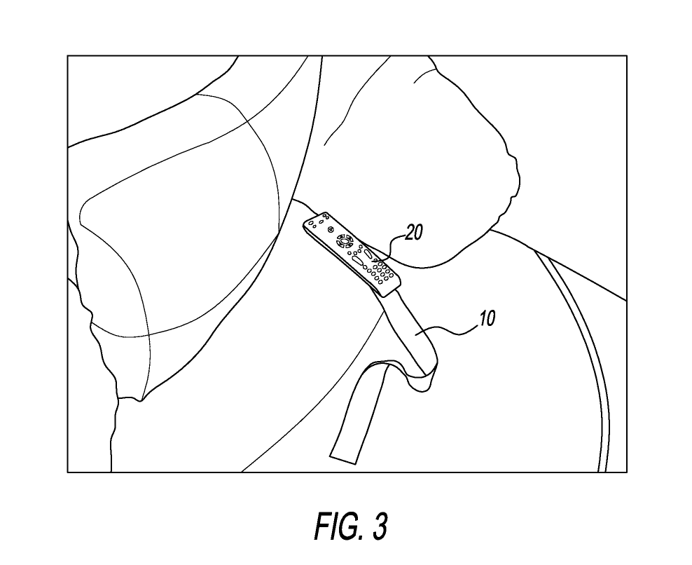

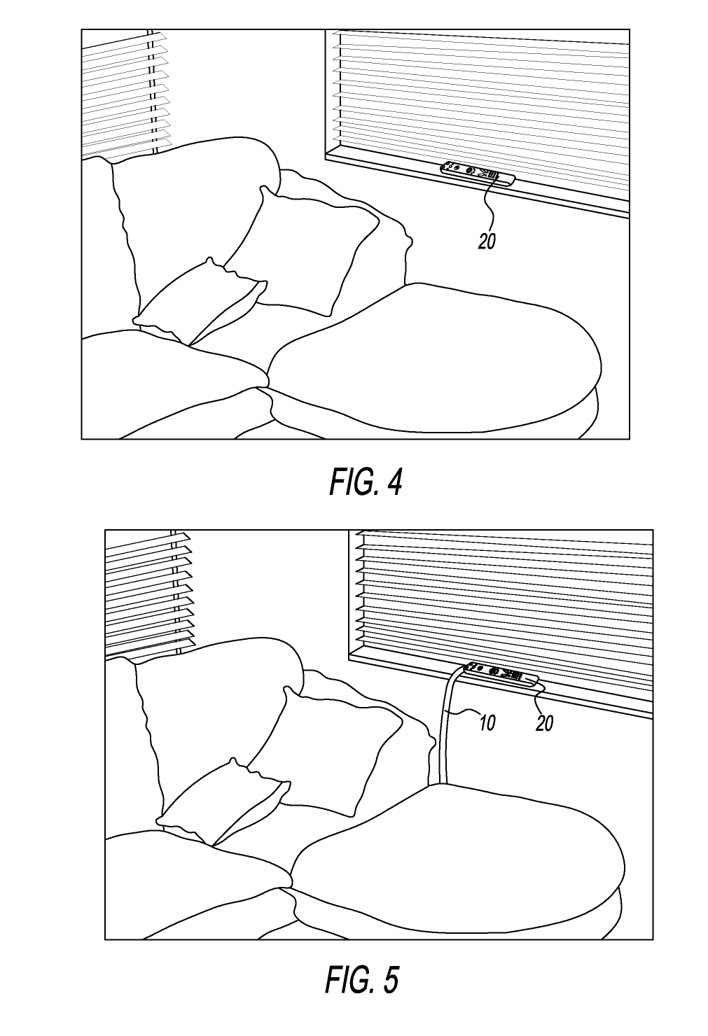

FIG. 3 shows an embodiment of the clicker keeper 10 applied to a remote control 20, preventing it from becoming lost between the cushions of a chair. FIG. 4 shows a remote control 20 placed on a window ledge, barely visible. FIG. 5 shows the aforementioned remote control 20, now highly-visible due to the application of the clicker keeper 10 of the present invention.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A clicker keeper substantially prevents the loss of remote controls and comprises a flag-like accessory; a first fastening means that is attached to one end of the flag-like accessory; and a second fastening means that matches with the first fastening means.

2. The clicker keeper of claim 1, wherein the flag-like accessory is a ribbon.

3. The clicker keeper of claim 2, wherein both the first and the second fastening means are strips of sticky-back fabric hook and loop fasteners; the first fabric hook and loop fastener is adhesively affixed to the ribbon and the second fabric hook and loop fasteners is adhesively affixed to the back of a desired remote control so that the ribbon can be removably applied to the desired remote control via the hook and loop fasteners.

4. The clicker keeper of claim 2, wherein the first fastening means may be a strip of fabric hook and loop fastener and may be sewn to the ribbon, and the second fastening means may be a strip of sticky-back fabric hook and loop fastener and may be adhesively affixed to the back of a desired remote control so that the ribbon can be removably applied to the desired remote control via the hook and loop fasteners.

5. The clicker keeper of claim 2, wherein the ribbon preferably measuring approximately 1.5 inches in width and 18 inches in length.

6. The clicker keeper of claim 2, wherein the ribbon can be made of any suitable, durable material, and may be available in a wide variety of colors, patterns and sizes to make them highly visible.

7. The clicker keeper of claim 2, wherein the ribbon can be interchangeable, allowing consumers to switch the colors and patterns applied to their remote controls as desired.

8. A method to ensure that remote controls are visible and ready for use comprising steps of removably attaching a highly visible flag-like accessory to a desired remote control.

9. The method of claim 8, wherein the highly visible flag-like accessory may be a ribbon with suitable fabric fasteners.
